(19) United States
(12) Patent Application Publication
(10) Pub. No.: US 2026/0296245 A1
(43) Pub. Date: Oct. 1, 2026

(54) POWER MANAGEMENT APPARATUS AND POWER MANAGEMENT METHOD

(71) Applicant: HONDA MOTOR CO., LTD., Tokyo (JP)

(72) Inventors: Takayuki Sakurai, Tokyo (JP); Seiya Nagase, Tokyo (JP)

(21) Appl. No.: 19/460,377

(22) Filed: Jan. 27, 2026

(30) Foreign Application Priority Data
Mar. 27, 2025 (JP) 2025-053352

(51) Int. Cl. B60L 53/62; G06Q 30/0207; H02J 3/32; H02J 105/37

(52) U.S. Cl. CPC B60L 53/62; G06Q 30/0207; H02J 3/322; H02J 2105/37

(57) ABSTRACT

A power management apparatus includes a request acceptor that accepts a demand response request for maintaining a supply and demand balance of electric power, a request executor that causes a power regulation resource including a traction storage battery of a vehicle and a stationary storage battery of a battery energy storage system to execute the demand response request, and a priority order determiner that determines priority order of the traction storage battery and the stationary storage battery, based on a type of the demand response request accepted by the request acceptor.

### CROSS-REFERENCE TO RELATED APPLICATIONS

This application is based on and claims the benefit of priority from Japanese Patent Application No. 2025-053352 filed in Japan on Mar. 27, 2025, the contents of which are hereby incorporated by reference in their entirety.

### BACKGROUND OF THE INVENTION

### Field of the Invention

The present invention relates to a power management apparatus and a power management method.

### Description of Related Art

In recent years, there is a vehicle-to-grid (V2G) technology for supplying electric power of a battery mounted on a vehicle to an electric power system. A demand response mechanism for balancing supply and demand of electric power by controlling charging and discharging of a battery mounted on a vehicle using this V2G technology is being studied. Hereinafter, the demand response may be referred to as “DR”.

Japanese Unexamined Patent Application, First Publication No. 2019-103333 discloses a constitution for the purpose of setting priority order of discharge of a plurality of storage batteries. An electric vehicle charger/discharger disclosed in Japanese Unexamined Patent Application, First Publication No. 2019-103333 includes an acceptor that accepts an instruction as to which of a first storage battery and a second storage battery electric power of which can be supplied to a load by discharge is prioritized, a discharge controller that starts discharge of the first storage battery when electric power supplied from a system power supply to the load exceeds a first threshold, and a changer that changes the first threshold on the basis of the second threshold. As the first storage battery, a traction battery for an electric vehicle is an exemplary example. As the second storage battery, a storage battery for a storage battery charger/discharger connected to an electric vehicle charger/discharger through a communication line is an exemplary example.

On the other hand, there is known a battery energy storage system (BESS) that interconnects a battery and an electric power control system in combination with an electric power system, and stores and discharges electric power as needed.

### SUMMARY OF THE INVENTION

In the future, there is a possibility of charging and discharging a plurality of storage batteries by using vehicles and a battery energy storage system in combination. Therefore, it is desired to optimally utilize resources when the vehicles and the battery energy storage system are used in combination.

In order to solve the above problem, an object of the present application is to provide a power management apparatus and a power management method capable of optimally utilizing resources.

As a means for solving the above problem, aspects of the present invention include following constitutions.

(1) A power management apparatus (for example, a power management apparatus 1 in an embodiment) according to an aspect of the present invention includes a request acceptor (for example, a request acceptor 20 in the embodiment) that accepts a demand response request for maintaining a supply and demand balance of electric power, a request executor (for example, a request executor 21 in the embodiment) that causes a power regulation resource including a traction storage battery (for example, a traction storage battery 4B in the embodiment) of a vehicle (for example, a vehicle 4 in the embodiment) and a stationary storage battery (for example, a stationary storage battery 6B in the embodiment) of a battery energy storage system (for example, a battery energy storage system 6 in the embodiment) to execute the demand response request, and a priority order determiner (for example, a priority order determiner 22 in the embodiment) that determines priority order of the traction storage battery and the stationary storage battery, based on a type of the demand response request accepted by the request acceptor.

In the power regulation resource, the traction storage battery of the vehicle and the stationary storage battery of the battery energy storage system have different uses. The traction storage battery of the vehicle is used for traveling and energy storage. On the other hand, the stationary storage battery of the battery energy storage system is exclusively used for energy storage. According to this constitution, resources can be optimally utilized by determining the priority order of the storage batteries (the traction storage battery and the stationary storage battery) having different uses, on the basis of the type of the demand response request.

(2) In the power management apparatus according to (1), in a case where the demand response request is a request for increasing power demand, the priority order determiner may determine priority in order of the traction storage battery and the stationary storage battery.

In the power regulation resource, the traction storage battery of the vehicle is not a resource that can always be charged and discharged. For example, a charging plug of a charge/discharge apparatus and a charging port of the vehicle are not always connected (fitted). According to this constitution, in a case where the demand response request is a request for increasing the power demand, it is possible to increase opportunities to participate in the demand response and a resource supply amount by prioritizing the traction storage battery of the vehicle.

(3) In the power management apparatus according to (1), in a case where the demand response request is a request for reducing power demand, the priority order determiner may determine priority in order of a charge reduction of the stationary storage battery, a charge reduction of the traction storage battery, an increased discharge of the stationary storage battery, and an increased discharge of the traction storage battery.

The charge reduction does not affect battery degradation even when reducing power demand. Therefore, the charge reduction has a higher priority than the discharge increase. The traction storage battery of the vehicle has two uses, and a remaining capacity (state of charge: SOC) of the battery is highly expected to decrease. The traction storage battery of the vehicle has a high risk associated with a decrease in the SOC from a viewpoint of securing the SOC for electric vehicle (EV) traveling. Therefore, the traction storage battery of the vehicle has a lower priority than the stationary storage battery of the battery energy storage system. According to this constitution, because the priority order is determined in consideration of the above, resources can be optimally utilized.

(4) In the power management apparatus according to any one of (1) to (3), a small-scale vehicle group classifier (for example, a small-scale vehicle group classifier 23 in the embodiment) that classifies the vehicle into a plurality of small-scale vehicle groups may be further included.

According to this constitution, traction storage batteries of vehicles classified into the plurality of small-scale vehicle groups can be optimally utilized as resources. For example, energy interchange between the battery energy storage system and the plurality of small-scale vehicle groups can be performed, and the traction storage batteries can be controlled as a group resource.

(5) In the power management apparatus according to any one of (1) to (4), a standby reward manager (for example, a standby reward manager 17 in the embodiment) that manages a reward to a user (for example, a user U in the embodiment) who has accepted the demand response request and has been on standby, and a record-based reward manager (for example, a record-based reward manager 18 in the embodiment) that manages a reward to a user who has accepted the demand response request and has executed the demand response may be further included.

According to this constitution, it is possible to increase opportunities for the user to receive the reward and improve motivation of the user to participate in the demand response.

(6) In the power management apparatus according to (5), in a case where the demand response request is a request for increasing power demand, the standby reward manager may not give a reward to the user.

Even in a case where the user has been on standby after accepting the demand response request, the SOC may increase when the demand response request is a request for increasing the power demand. In principle, there is no disadvantage with increased SOC for the power regulation resources (the traction storage battery of the vehicle and the stationary storage battery for the battery energy storage system). According to this constitution, in the above case, the reward is not given to the user, by which charging is performed, which is advantageous to the user, and thus it is possible to perform control that does not require the reward.

(7) In the power management apparatus according to (5), in a case where the demand response request is a request for reducing power demand, the standby reward manager may give a reward to the user.

According to this constitution, the SOC may be reduced when the demand response request is a request for reducing the power demand, and thus, it is possible to increase opportunities for the user to receive the reward and improve motivation of the user to participate in the demand response.

(8) In a power management method according to an aspect of the present invention, a computer (for example, a controller 10 in the embodiment) of a power management apparatus (for example, the power management apparatus 1 in an embodiment) accepts a demand response request for maintaining a supply and demand balance of electric power, causes a power regulation resource including a traction storage battery (for example, the traction storage battery 4B in the embodiment) of a vehicle (for example, the vehicle 4 in the embodiment) and a stationary storage battery (for example, a stationary storage battery 6B of the embodiment) of a battery energy storage system (for example, the battery energy storage system 6 in the embodiment) to execute the demand response request, and determines priority order of the traction storage battery and the stationary storage battery, based on a type of the demand response request.

According to this method, the resources can be optimally utilized by determining the priority order of the storage batteries (the traction storage battery and the stationary storage battery) having different uses, on the basis of the type of the demand response request.

According to the aspects of the present invention, resources can be optimally utilized.

### BRIEF DESCRIPTION OF THE DRAWINGS

FIG. 1 is a diagram illustrating an example of a power management system including a power management apparatus according to an embodiment;

FIG. 2 is a functional block diagram illustrating an example of a terminal device according to the embodiment;

FIG. 3 is a flowchart illustrating an example of a flow of setting processing of the power management apparatus according to the embodiment;

FIG. 4 is a diagram illustrating an example of an acceptable standard value setting screen displayed on the terminal device according to the embodiment;

FIG. 5 is a flowchart illustrating an example of a flow of DR control of the power management apparatus according to the embodiment;

FIG. 6 is a flowchart illustrating an example of a flow of DR control based on a DR request according to the embodiment;

FIG. 7 is a diagram illustrating an example of determination of priority order in a case where the DR request according to the embodiment is an increasing DR; and

FIG. 8 is a diagram illustrating an example of determination of priority order in a case where a DR request according to the embodiment is a reducing DR.

### DETAILED DESCRIPTION OF THE INVENTION

Hereinafter, a power management apparatus and a power management method according to an embodiment of the present invention will be described with reference to the drawings.

### Overall constitution

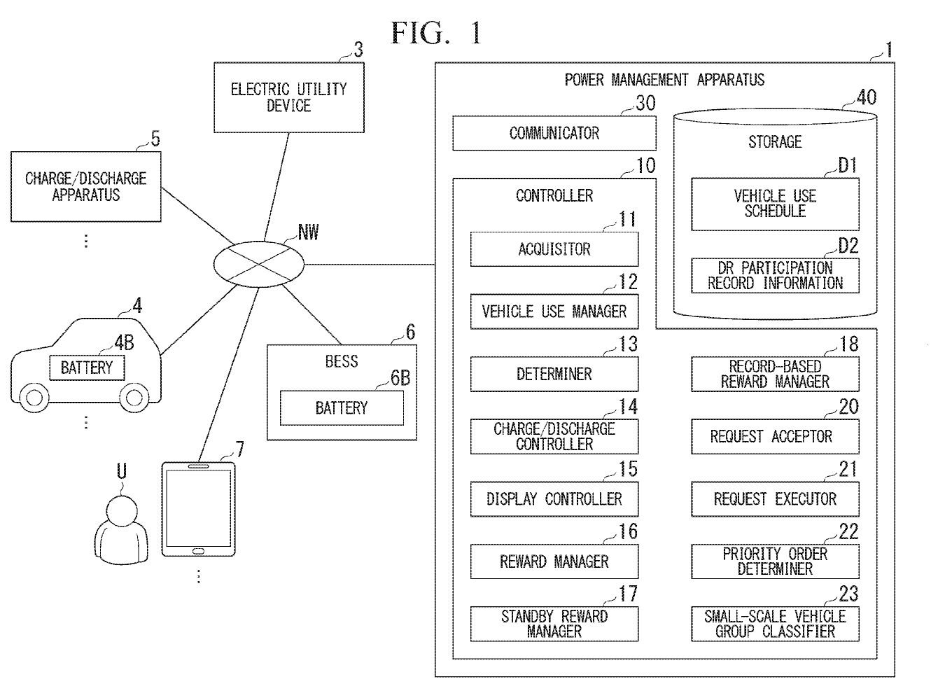

FIG. 1 is a diagram illustrating an example of a power management system S including a power management apparatus 1 according to the present embodiment.

The power management system S uses a technology of V2G that supplies electric power of a battery mounted on a vehicle to an electric power system, and a technology of supplying electric power of a battery energy storage system (BESS) in combination to the electric power system. The power management system controls demand response by controlling charging and discharging of each battery of a vehicle and BESS by using the above-described two technologies in combination. Hereinafter, the control of the demand response may be referred to as “DR control”.

As illustrated in FIG. 1, the power management system S includes the power management apparatus 1, an electric utility device 3, a charge/discharge apparatus 5, a terminal device 7, a vehicle 4, and a battery energy storage system 6 (BESS). The power management apparatus 1, the electric utility device 3, the charge/discharge apparatus 5, the terminal device 7, the vehicle, the BESS, and the like are communicably connected to each other via a communication network NW. Examples of the communication network include the Internet, a mobile communication network, a wide area network (WAN), a local area network (LAN), a cellular network, and the like.

The power management apparatus 1 performs overall control of the power management system S. The power management apparatus 1 controls charging and discharging of a battery 4B mounted on the vehicle 4 connected to the charge/discharge apparatus 5 according to a demand response plan received from the electric utility device 3, and controls charging and discharging of a battery 6B provided on the BESS, for example. The battery 4B mounted on the vehicle 4 corresponds to a traction storage battery 4B of the vehicle 4. The battery 6B provided on the BESS corresponds to a stationary storage battery 6B of the battery energy storage system 6. Hereinafter, the demand response plan may be referred to as a “DR plan”.

The vehicle 4 is, for example, a vehicle such as a four-wheel, a two-wheel, and a three-wheel vehicle. A drive source of the vehicle may be, for example, an electric motor. Alternatively, the drive source of the vehicle may be a combination of an internal combustion engine such as a diesel engine or a gasoline engine and an electric motor. The electric motor operates by using discharge power of the battery 4B which is a secondary battery or a fuel cell, or power generated by a generator connected to the internal combustion engine. Examples of the vehicle 4 include an electric vehicle, a hybrid vehicle, a fuel cell vehicle, an electric motorcycle, and the like. In the present embodiment, the vehicle is an electric vehicle (EV). Hereinafter, a battery mounted on an EV (vehicle) may be referred to as an “EV battery”.

The electric utility device 3 is used by a company that supplies electricity, such as a power transmission and distribution company or a retail electricity company. The electric utility device 3 makes a DR plan according to a state of power storage, and notifies a consumer of electric power such as a company and a home. In the power management system S, the electric utility device 3 transmits the DR plan to the power management apparatus 1 via the communication network NW.

The charge/discharge apparatus 5 charges and discharges the EV battery. The charge/discharge apparatus 5 is installed, for example, in a residence of a user U of the vehicle 4 or a public charging station. The charge/discharge apparatus 5 charges the EV battery by using system energy or renewable energy. The system energy is, for example, energy supplied from a general distribution line network (system, commercial power supply). The renewable energy is, for example, energy generated by a power generation apparatus provided in a house or the like.

In addition, the charge/discharge apparatus 5 discharges the EV battery by returning the electric power accumulated in the EV battery to the system.

The vehicle 4 is used by the user U, for example. The user U is, for example, a driver. Upon returning to his/her house, the user U connects (fits) a charging plug of the charge/discharge apparatus 5 provided in the house to a charging port of the vehicle 4, and thus charging and discharging of the vehicle 4 is enabled. Alternatively, the user U goes to a charging station and connects (fits) a charging plug of the charge/discharge apparatus 5 provided in the charging station to the charging port of the vehicle 4, and thus charging and discharging of the vehicle 4 is enabled.

The terminal device 7 is used by the user U, for example. The terminal device 7 is, for example, a smartphone, a tablet terminal, a general-purpose personal computer, or the like. The terminal device 7 may be connected to the vehicle 4 to function as an in-vehicle device. The terminal device 7 transmits information input by the user U to the power management apparatus 1 and the like. In addition, the terminal device 7 outputs information transmitted from the power management apparatus 1 to notify the user U of the information. The terminal device 7 implements various functions for participating in the DR control by executing a demand response application installed in advance. Hereinafter, the demand response application may be referred to as “DR application”. Note that the various functions described above may be implemented by using a general-purpose application program such as a web browser operating on the terminal device 7.

The BESS is installed, for example, in a company, a laboratory, or the like. The BESS is a system that stores energy in a battery and distributes the energy as needed to maintain stability of a power network. The BESS can be integrated with a renewable energy source by utilizing a technology such as a lithium-ion battery, for example. Hereinafter, the battery 6B provided on the BESS may be referred to as a “BESS battery”.

The BESS may include a battery management system (BMS) that manages the BESS battery, an auxiliary system that assists the battery management system, a power conversion system (power conditioning system: PCS) that converts electric power between DC power and AC power, and an energy management system (EMS) that manages energy.

The BESS battery may be a secondary use of the EV battery. The BESS battery may be, for example, a used EV battery (battery of a used car). The BESS battery may be, for example, one that has passed a predetermined period from a time of production, within a service life of the EV battery. The mode of the BESS battery is not limited to the above one, and can be changed according to a design specification.

### Power management apparatus

The power management apparatus 1 includes a controller 10, a communicator 30, and a storage 40.

The controller 10 controls an entire operation of the power management apparatus 1. The controller 10 includes an acquisitor 11, a vehicle use manager 12, a determiner 13, a charge/discharge controller 14, a display controller 15, a reward manager 16, a request acceptor 20, a request executor 21, a priority order determiner 22, and a small-scale vehicle group classifier 23.

These functional units of the controller 10 are implemented by, for example, a hardware processor (computer) such as a central processing unit (CPU) executing a program (software).

Some or all of these constituent elements may be implemented by a hardware such as a large-scale integration (LSI), an application specific integrated circuit (ASIC), a field-programmable gate array (FPGA), a graphics processing unit (GPU), or system on chip (SOC) or may be implemented by software and hardware in cooperation. In addition, the power management apparatus 1 is not limited to a single apparatus, and a plurality of apparatuses may cooperate to implement the respective functional units of the controller 10.

The acquisitor 11 acquires various types of information from an external device via the communication network NW. In addition, the acquisitor 11 acquires various types of information stored in the storage 40. For example, the acquisitor 11 acquires input information of a vehicle use schedule by the user U of the vehicle 4, an acceptable standard value set by the user U, the remaining capacity of the EV battery, and the remaining capacity of the BESS battery.

The vehicle use manager 12 manages a vehicle use schedule of the vehicle 4. For example, the vehicle use manager 12 registers a vehicle use schedule input by the user U via the terminal device 7 in a vehicle use schedule D1 stored in the storage 40 in association with the user U or the vehicle 4.

The determiner 13 determines whether or not the vehicle use schedule of the user U to be determined has been input, based on the vehicle use schedule D1.

The charge/discharge controller 14 may control the charging and discharging of the EV battery, based on the determination result of whether or not the vehicle use schedule has been input, the acceptable standard value, and the remaining capacity of the EV battery. In addition, in a case where the acceptable standard value is not set by the user U, the charge/discharge controller 14 may perform adjustment by using a predetermined reference value (for example, DR usable SOC: 50% or the like) as the acceptable standard value.

The display controller 15 performs display control of a display of the terminal device 7. The display controller 15 generates notification information (information indicating display contents) to the user, based on processing results of various functions of the controller 10, and transmits the notification information to the terminal device 7. As a result, various types of information are displayed on the display of the terminal device 7.

The reward manager 16 manages a reward to the user U according to a record of participation in exchange of power between the EV battery and an external power source (for example, an electric power system or an electric power transaction market). The reward manager 16 may also give a reward to the user U in a case where the vehicle 4 stands by for participation in a state where electric power can be exchanged, in addition to a case where the vehicle 4 participates in the exchange of power. The reward in the case where the vehicle 4 stands by for participation may be set to be lower than the reward in the case where the vehicle 4 participates.

The reward manager 16 includes a standby reward manager 17 that manages a reward to a user who has accepted a demand response request and has been on standby, and a record-based reward manager 18 that manages a reward to a user who has accepted the demand response request and has executed the demand response. Hereinafter, the demand response request may be referred to as “DR request”.

In the present embodiment, in a case where the DR request is a request for increasing power demand, the standby reward manager 17 does not give a reward to the user. Hereinafter, the request for increasing the power demand may be referred to as “increasing DR”.

In a case where the DR request is a request for reducing power demand, the standby reward manager 17 gives a reward to the user. Hereinafter, the request for reducing the power demand may be referred to as “reducing DR”.

The request acceptor 20 accepts the DR request.

The request executor 21 causes a power regulation resource including the EV battery and the BESS battery to execute the DR request. The power regulation resource may include batteries (resources) other than the EV battery and the BESS battery.

The priority order determiner 22 determines priority order of the EV battery and the BESS battery on the basis of a type of the DR request accepted by the request acceptor 20. The types of the DR request include increasing DR and reducing DR.

The small-scale vehicle group classifier 23 classifies vehicles into the plurality of small-scale vehicle groups. For example, the small-scale vehicle group classifier 23 may classify the vehicles into 2 to 10 small-scale vehicle groups. The number of vehicles in a small-scale vehicle group may be set to, for example, 2 to 100. Note that the number of classification of the small-scale vehicle group and the number of vehicles in a small-scale vehicle group are not limited to the above, and can be changed according to the design specification.

The communicator 30 communicates with external devices such as the electric utility device 3, the charge/discharge apparatus 5, the terminal device 7, the vehicle 4, and the BESS via the communication network NW. The communicator 30 is, for example, a network card for connecting to the communication network NW.

The storage 40 stores various types of information necessary for the DR control. The storage 40 is implemented by, for example, an HDD, a flash memory, an electrically erasable programmable read only memory (EEPROM), a read only memory (ROM), a random access memory (RAM), or the like. The storage 40 stores, for example, the vehicle use schedule D1, DR participation record information D2, and the like. Note that the storage 40 may be implemented by another storage device, such as an external storage server device, connected via the communication network NW.

### Terminal device

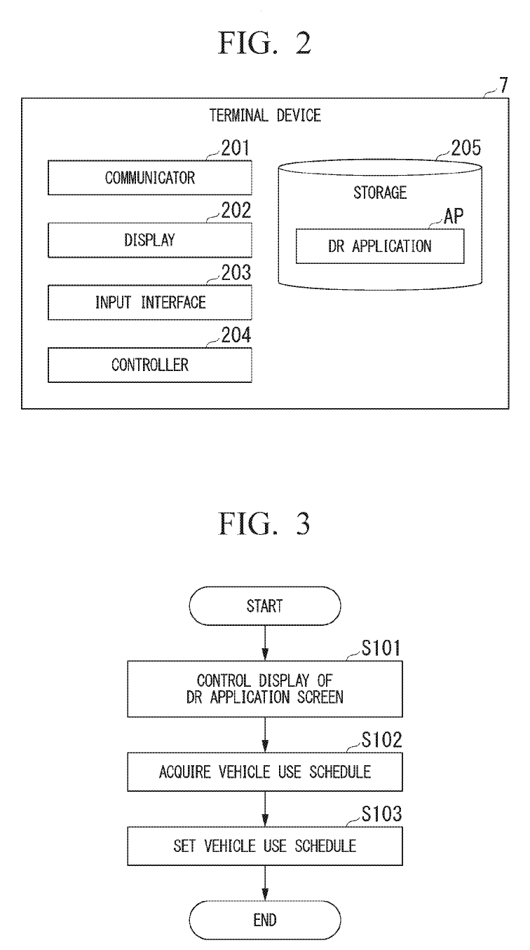

FIG. 2 is a functional block diagram illustrating an example of the terminal device 7 according to the embodiment.

As illustrated in FIG. 2, the terminal device 7 includes a communicator 201, a display 202, an input interface 203, a controller 204, and a storage 205.

The communicator 201 communicates with external devices such as the power management apparatus 1, the electric utility device 3, the charge/discharge apparatus 5, the vehicle 4, and the BESS via the communication network NW. The communicator 201 is, for example, a network card for connecting to the communication network NW.

The display 202 displays various types of information on the DR control. The display 202 displays an image generated by the controller 204, a graphical user interface (GUI) for accepting various input operations from the user U, and the like. The display 202 is, for example, a liquid crystal display (LCD), an organic electro luminescence (EL) display, and the like.

The input interface 203 accepts various input operations from the user U, converts the accepted input operations into electrical signals, and outputs the electrical signals to the controller 204. For example, the input interface 203 includes a touch panel, a keyboard, a mouse, and the like.

The controller 204 controls an entire operation of the terminal device 7. For example, the controller 204 executes a DR application AP stored in the storage 205 to implement various functions for participating in the DR control. For example, the controller 204 implements a vehicle use schedule input function, a setting function of an acceptable standard value, a reward management function, and the like.

The storage 205 stores various types of information related to the DR. The storage 205 is implemented by, for example, an HDD, a flash memory, an EEPROM, a ROM, a RAM, or the like. The storage 205 stores, for example, the DR application AP, and the like.

### Setting processing

FIG. 3 is a flowchart illustrating an example of a flow of setting processing of the power management apparatus 1 according to the embodiment. The process illustrated in FIG. 3 is started, for example, when the user U operates the terminal device 7 to activate the DR application AP.

As illustrated in FIG. 3, first, in response to a request transmitted from the terminal device 7, the display controller 15 transmits screen information for inputting various types of information related to the DR to the terminal device 7 (step S101).

In step S101, for example, the display controller 15 transmits screen information or the like for setting the vehicle use schedule to the terminal device 7. As a result, various screens (vehicle use schedule setting screen and the like) are displayed on the display 202 of the terminal device 7. The various screens include an acceptable standard value setting screen. After step S101, the process proceeds to step S103.

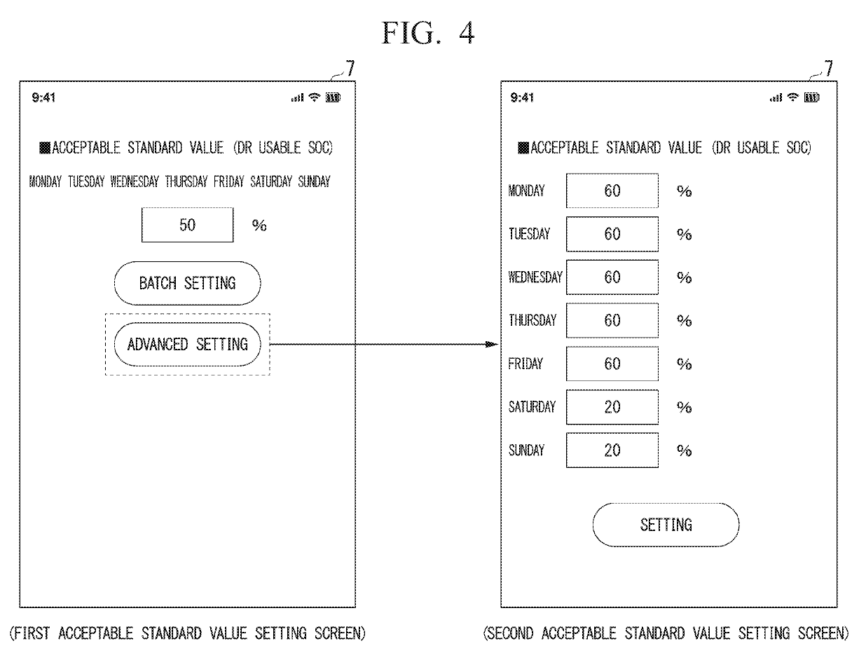

FIG. 4 is a diagram illustrating an example of an acceptable standard value setting screen displayed on the terminal device 7 according to the embodiment.

As illustrated in FIG. 4, on a first acceptable standard value setting screen, it may be possible to set an acceptable standard value (single value) common in the entire period (from Monday to Sunday). In addition, a second acceptable standard value setting screen may be displayed by pressing an “advanced setting” button provided on the first acceptable standard value setting screen. In the second acceptable standard value setting screen, the acceptable standard values (a plurality of values) may be set for each arbitrary period such as each day of the week. In addition, an acceptable standard value setting screen on which an acceptable standard value can be set for each time period may be used.

Returning to FIG. 3, in step S102, the acquisitor 11 acquires from the terminal device 7 the vehicle use schedule input by the user U via the terminal device 7. In addition, the acquisitor 11 may acquire from the terminal device 7 the acceptable standard value input by the user U via the terminal device 7. After step S102, the process proceeds to step S103.

In step S103, the vehicle use manager 12 sets the acquired vehicle use schedule in the vehicle use schedule D1 stored in the storage 40 in association with the user U. In addition, in step S103, the acquired acceptable standard value may be set to the acceptable standard value stored in the storage 40 in association with the user U.

Thus, the process in this flowchart ends.

### DR control processing

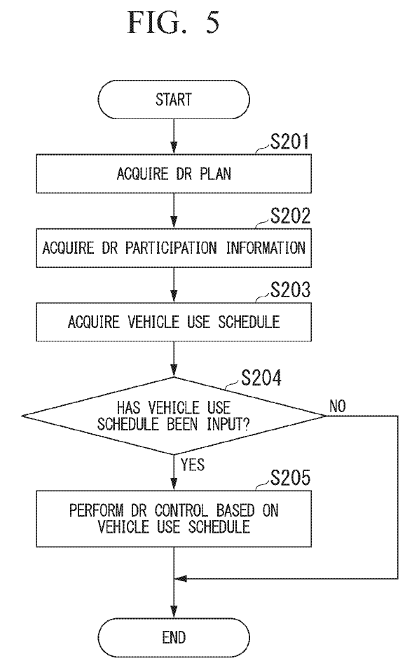

FIG. 5 is a flowchart illustrating an example of a flow of the DR control of the power management apparatus 1 according to the embodiment. The process illustrated in FIG. 5 is started, for example, at a predetermined timing when the DR control is executed. In addition, the description will be given assuming that the vehicle use schedule D1 set by each user U is already stored in the storage 40 of the power management apparatus 1. In addition, there are a plurality of vehicles 4 as targets of the DR control, and the power management apparatus 1 executes the following process on each of the plurality of vehicles 4.

As illustrated in FIG. 5, the acquisitor 11 first acquires the DR plan transmitted from the electric utility device 3 (step S201). After step S201, the process proceeds to step S202.

In step S202, the acquisitor 11 acquires, from the charge/discharge apparatus 5, information on a user of a vehicle who can participate in the DR control (a user of the vehicle whose charging port is fitted to the charging plug of charge/discharge apparatus 5). Hereinafter, the information on the user of the vehicle who can participate in the DR control may be referred to as “DR participation information”. After step S202, the process proceeds to step S203.

In step S203, the acquisitor 11 acquires each piece of information associated with the user included in the DR participation information, from the vehicle use schedule D1 stored in the storage 40. After step S203, the process proceeds to step S204.

In step S204, the determiner 13 determines whether or not the vehicle use schedule of the user U to be determined has been input, based on the acquired vehicle use schedule. For example, the determiner 13 determines whether or not the vehicle use schedule of the user U has been input on an execution date of the DR control. In a case where it is determined that the vehicle use schedule has been input (S204; YES), the process proceeds to step S205. On the other hand, in a case where it is determined that the vehicle use schedule has not been input (S204; NO), the process ends.

In step S205, the charge/discharge controller 14 performs the DR control based on the vehicle use schedule. For example, in a case where departure time “8:00” and home arrival time “17:00” are set as the vehicle use schedule, the charge/discharge controller 14 performs the DR control so as not to participate in the DR control during a period from 8:00 to 17:00. In addition, the charge/discharge controller 14 may control the charging and discharging of the battery 4B so that remaining capacity of the battery 4B reaches a predetermined value or more at the timing of the departure time “8:00” (so as to secure the remaining capacity that does not affect the use of the vehicle).

Note that, in a case where it is determined that the vehicle use schedule has not been input (S204; NO), the charge/discharge controller 14 may perform the DR control based on the acceptable standard value. For example, in a case where “SOC: 50%” is set as the acceptable standard value, the charge/discharge controller 14 may perform the DR control so as not to participate in the DR control when the acquired remaining capacity (SOC) of the EV battery is less than 50%.

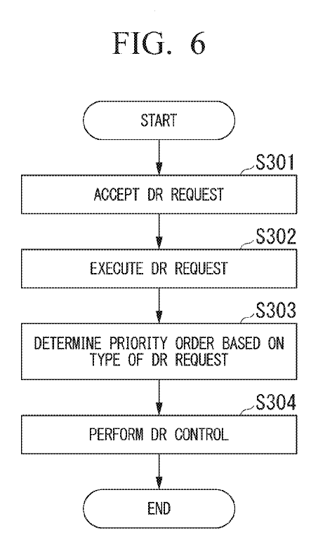

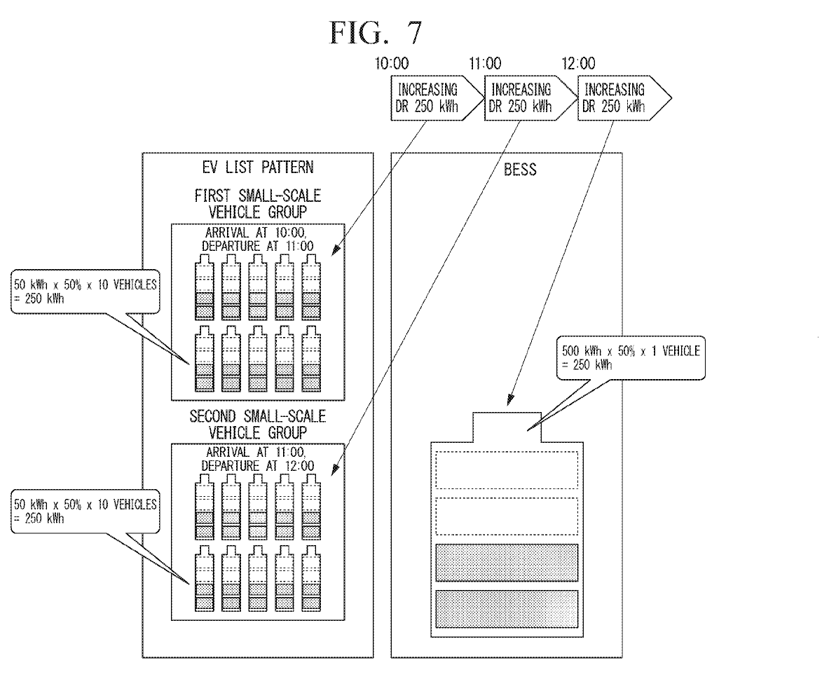

FIG. 6 is a flowchart illustrating an example of a flow of DR control based on the DR request according to the embodiment. The process illustrated in FIG. 6 is started, for example, at a predetermined timing when the DR control is executed. In addition, there are a plurality of vehicles (small-scale vehicle groups) and BESS as targets of the DR control, and the power management apparatus 1 executes the following process on the vehicles (small-scale vehicle groups) and the BESS.

As illustrated in FIG. 6, first, the request acceptor 20 accepts the DR request (step S301). After step S301, the process proceeds to step S302.

In step S302, the request executor 21 causes the power regulation resource including the EV battery and the BESS battery to execute the DR request. After step S302, the process proceeds to step S303.

In step S303, the priority order determiner 22 determines priority order of the EV battery and the BESS battery on the basis of the type of the DR request accepted by the request acceptor 20. After step S303, the process proceeds to step S304.

In step S304, the charge/discharge controller 14 performs DR control on the EV battery and the BESS battery.

Thus, the process in this flowchart ends.

### Determination of priority order in a case where DR request is increasing DR

FIG. 7 is a diagram illustrating an example of determination of priority order in a case where the DR request according to the embodiment is the increasing DR.

As illustrated in FIG. 7, in a case where the DR request is the increasing DR, the priority order determiner 22 determines the priority in order of the EV battery and the BESS battery.

In the example in FIG. 7, in an EV list pattern, EVs are classified into two small-scale vehicle groups (battery capacity: 50 kWh, SOC: 50%, number of vehicles: 10). A vehicle use schedule for arrival at 10:00 and departure at 11:00 is set for a first small-scale vehicle group (battery capacity: 50 kWh, SOC: 50%, number of vehicles: 10). A vehicle use schedule for arrival at 11:00 and departure at 12:00 is set for a second small-scale vehicle group (battery capacity: 50 kWh, SOC: 50%, number of vehicles: 10).

The BESS is set such that the battery capacity is 500 kWh, the SOC is 50%, and the number of installations is 1.

In the example in FIG. 7, the priority order determiner 22 determines priority in order of the first small-scale vehicle group, the second small-scale vehicle group, and the BESS. In this case, the charge/discharge controller 14 controls the increasing DR for the first small-scale vehicle group, the second small-scale vehicle group, and the BESS in that order. The control of the increasing DR is control for increasing power demand in response to a request from an electricity provider or the like. Upon starting of the control of the increasing DR, the battery is charged and the SOC increases.

First, from 10:00 to 11:00, the charge/discharge controller 14 causes the first small-scale vehicle group to charge the battery as the control of the increasing DR (for 10 vehicles: 250 kWh, 25 kWh per vehicle). Next, from 11:00 to 12:00, the charge/discharge controller 14 causes the second small-scale vehicle group to charge the battery as the control of the increasing DR (for 10 vehicles: 250 kWh, 25 kWh per vehicle). Next, from 12:00, the charge/discharge controller 14 causes the BESS to charge the battery as the control of the increasing DR (250 kWh per vehicle).

### Determination of priority order in a case where DR request is reducing DR

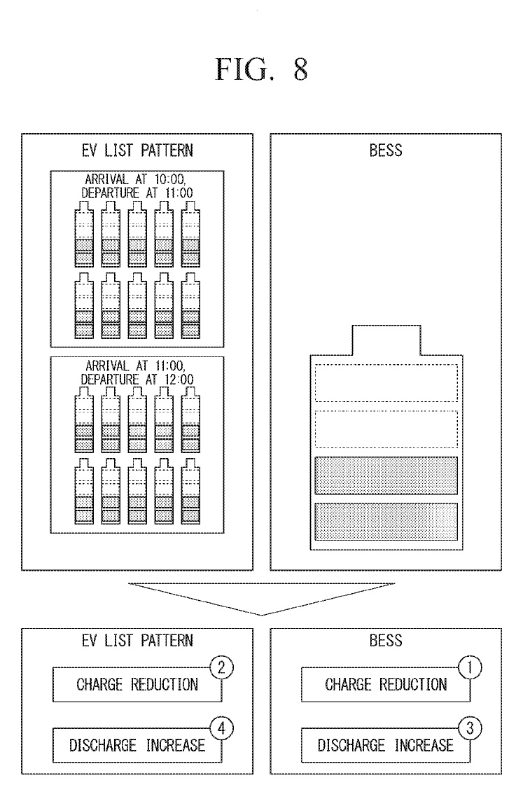

FIG. 8 is a diagram illustrating an example of determination of priority order in a case where the DR request according to the embodiment is the reducing DR.

As illustrated in FIG. 8, in a case where the DR request is the reducing DR, the priority order determiner 22 determines the priority in order of a charge reduction of the BESS battery, a charge reduction of the EV battery, an increased discharge of the BESS battery, and an increased discharge of the EV battery.

The charge reduction includes charging for a period shorter than a predetermined period (for example, 1 hour out of 3 hours), charging by an amount smaller than a predetermined charge amount (for example, 5 kWh out of 10 kWh), stopping charging although the charging is scheduled, and the like.

The discharge increase includes discharging for a period longer than a predetermined period (for example, a period (two hours) longer than scheduled one hour), discharging by an amount larger than the predetermined discharge amount (for example, an amount (10 kWh) larger than a scheduled 5 kWh), discharging although the discharge is scheduled to be stopped, and the like.

Examples of the reason for determining the priority in the above order when the DR request is the reducing DR include the following (1) and (2).
(1) The charge reduction does not affect battery degradation even when reducing power demand. Therefore, the charge reduction has a higher priority than the discharge increase.
(2) The EV battery has two uses (traveling and energy storage). The remaining capacity (SOC) of the EV battery is highly expected to decrease. The EV battery has a high risk associated with a decrease in the SOC from a viewpoint of securing the SOC for EV traveling. Therefore, the EV battery has a lower priority than the BESS battery.

### Operation and effects

As described above, the power management apparatus 1 according to the above embodiment includes a request acceptor 20 that accepts a demand response request for maintaining a supply and demand balance of electric power, a request executor 21 that causes a power regulation resource including a traction storage battery 4B of a vehicle 4 and a stationary storage battery 6B of a battery energy storage system 6 to execute the demand response request, and a priority order determiner 22 that determines priority order of the traction storage battery 4B and the stationary storage battery 6B, based on a type of the demand response request accepted by the request acceptor 20.

In the power regulation resource, the traction storage battery 4B of the vehicle 4 and the stationary storage battery 6B of the battery energy storage system 6 have different uses. The traction storage battery 4B of the vehicle 4 is used for traveling and energy storage. On the other hand, the stationary storage battery 6B of the battery energy storage system 6 is exclusively used for energy storage. According to this constitution, the resources can be optimally utilized by determining the priority order of the storage batteries (traction storage battery 4B and stationary storage battery 6B) having different uses, on the basis of the type of the demand response request.

In the above embodiment, in a case where the demand response request is a request for increasing power demand, the priority order determiner 22 determines priority in order of the traction storage battery 4B and the stationary storage battery 6B.

In the power regulation resource, the traction storage battery 4B of the vehicle 4 is not a resource that can always be charged and discharged. For example, the charging plug of the charge/discharge apparatus 5 and the charging port of the vehicle 4 are not always connected (fitted). According to this constitution, in a case where the demand response request is a request for increasing the power demand, it is possible to increase opportunities to participate in the demand response and a resource supply amount by prioritizing the traction storage battery 4B of the vehicle 4.

In the above embodiment, in a case where the demand response request is a request for reducing power demand, the priority order determiner 22 determines priority in order of a charge reduction of the stationary storage battery 6B, a charge reduction of the traction storage battery 4B, an increased discharge of the stationary storage battery 6B, and an increased discharge of the traction storage battery 4B.

The charge reduction does not affect battery degradation even when reducing power demand. Therefore, the charge reduction has a higher priority than the discharge increase. The traction storage battery 4B of the vehicle 4 has two uses, and a remaining capacity (SOC) of the battery is highly expected to decrease. The traction storage battery 4B of the vehicle 4 has a high risk associated with a decrease in the SOC from a viewpoint of securing the SOC for EV traveling. Therefore, the traction storage battery 4B of the vehicle 4 has a lower priority than the stationary storage battery 6B of the battery energy storage system 6. According to this constitution, because the priority order is determined in consideration of the above, resources can be optimally utilized.

For example, there is a demand for the traction storage battery 4B of the vehicle 4 to give maximum consideration to deterioration due to a decrease in EV asset value. On the other hand, in a case where the stationary storage battery 6B of the battery energy storage system 6 is a secondary use of the traction storage battery 4B of the vehicle 4, it is possible to meet a demand for using up the traction storage battery 6B.

In the above embodiment, a small-scale vehicle group classifier 23 that classifies the vehicle 4 into a plurality of small-scale vehicle groups is further included.

According to this constitution, the traction storage batteries 4B of vehicles 4 classified into the plurality of small-scale vehicle groups can be optimally utilized as resources. For example, energy interchange between the battery energy storage system 6 and the plurality of small-scale vehicle groups can be performed, and the traction storage batteries 4B can be controlled as a group resource.

In the above embodiment, a standby reward manager 17 that manages a reward to a user U who has accepted the demand response request and has been on standby, and a record-based reward manager 18 that manages a reward to a user U who has accepted the demand response request and has executed the demand response are further included.

According to this constitution, it is possible to increase opportunities for the user U to receive the reward and improve motivation of the user U to participate in the demand response.

In the above embodiment, in a case where the demand response request is a request for increasing power demand, the standby reward manager 17 does not give a reward to the user U.

Even in a case where the user U has been on standby after accepting the demand response request, the SOC may increase when the demand response request is a request for increasing the power demand. In principle, there is no disadvantage with increased SOC for the power regulation resources (the traction storage battery 4B of the vehicle 4 and the stationary storage battery 6B for the battery energy storage system 6). According to this constitution, in the above case, the reward is not given to the user U, by which charging is performed, which is advantageous to the user U, and thus it is possible to perform control that does not require the reward.

In the above embodiment, in a case where the demand response request is a request for reducing power demand, the standby reward manager 17 gives a reward to the user U.

According to this constitution, the SOC may be reduced when the demand response request is a request for reducing the power demand, and thus, it is possible to increase opportunities for the user U to receive the reward in a case as described above, and improve motivation of the user U to participate in the demand response.

In a power management method in the above embodiment, a computer (a controller 10) of a power management apparatus 1 accepts a demand response request for maintaining a supply and demand balance of electric power, causes a power regulation resource including a traction storage battery 4B of a vehicle 4 and a stationary storage battery 6B of a battery energy storage system 6 to execute the demand response request, and determines priority order of the traction storage battery 4B and the stationary storage battery 6B, based on a type of the demand response request.

According to this method, the resources can be optimally utilized by determining the priority order of the storage batteries (traction storage battery 4B and stationary storage battery 6B) having different uses, on the basis of the type of the demand response request.

### Modifications

In the above embodiment, an example has been described in which, in a case where the demand response request is a request for increasing power demand, the priority order determiner determines priority in order of the traction storage battery and the stationary storage battery, but the present invention is not limited thereto. For example, in a case where the demand response request is a request for increasing power demand, the priority order determiner may determine priority in order of the stationary storage battery and the traction storage battery. The mode of determining the priority order in a case where the demand response request is a request for increasing power demand can be changed according to the design specification.

In the above embodiment, an example has been described in which, in a case where the demand response request is a request for reducing power demand, the priority order determiner determines priority in order of a charge reduction of the stationary storage battery, a charge reduction of the traction storage battery, an increased discharge of the stationary storage battery, and an increased discharge of the traction storage battery, but the present invention is not limited thereto. For example, in a case where the demand response request is a request for reducing power demand, the priority order determiner may determine priority in order of a charge reduction of the stationary storage battery, an increased discharge of the stationary storage battery, a charge reduction of the traction storage battery, and an increased discharge of the traction storage battery. The mode of determining the priority order in a case where the demand response request is a request for reducing power demand can be changed according to the design specification.

In the above embodiment, an example has been described in which a small-scale vehicle group classifier that classifies vehicles into a plurality of small-scale vehicle groups is further included, but the present invention is not limited thereto. For example, the vehicles may be classified into large-scale vehicle groups of a predetermined number or more. For example, the vehicles may not be classified into a plurality of vehicle groups. The mode of classifying the vehicles can be changed according to the design specification.

In the above embodiment, an example has been described in which a standby reward manager that manages a reward to a user who has accepted the demand response request and has been on standby, and a record-based reward manager that manages a reward to a user who has accepted the demand response request and has executed the demand response are further included, but the present invention is not limited thereto. For example, the power management apparatus may not include the standby reward manager that manages the reward to the user who has accepted the demand response request and has been on standby. For example, the power management apparatus may not include the record-based reward manager that manages the reward to the user who has accepted the demand response request and has executed the demand response. The mode of installing the standby reward manager and the record-based reward manager can be changed according to the design specification.

In the above embodiment, an example has been described in which, in a case where the demand response request is a request for increasing power demand, the standby reward manager does not give a reward to the user, but the present invention is not limited thereto. For example, in a case where the demand response request is a request for increasing power demand, the standby reward manager may give the reward to the user. The mode of the standby reward manager in a case where the demand response request is a request for increasing power demand can be changed according to the design specification.

In the above embodiment, an example has been described in which, in a case where the demand response request is a request for reducing power demand, the standby reward manager gives a reward to the user, but the present invention is not limited thereto. For example, in a case where the demand response request is a request for reducing power demand, the standby reward manager may not give the reward to the user. The mode of the standby reward manager in a case where the demand response request is a request for reducing power demand can be changed according to the design specification.

Heretofore, the modes for carrying out the present invention have been described with embodiments, but the present invention is not limited to the embodiments described above, and various modifications and substitutions can be made without departing from the gist of the present invention.

What is claimed is:

1. A power management apparatus comprising:
a request acceptor that accepts a demand response request for maintaining a supply and demand balance of electric power;
a request executor that causes a power regulation resource including a traction storage battery of a vehicle and a stationary storage battery of a battery energy storage system to execute the demand response request; and
a priority order determiner that determines priority order of the traction storage battery and the stationary storage battery, based on a type of the demand response request accepted by the request acceptor.

2. The power management apparatus according to claim 1, wherein
in a case where the demand response request is a request for increasing power demand, the priority order determiner determines priority in order of the traction storage battery and the stationary storage battery.

3. The power management apparatus according to claim 1, wherein
in a case where the demand response request is a request for reducing power demand, the priority order determiner determines priority in order of a charge reduction of the stationary storage battery, a charge reduction of the traction storage battery, an increased discharge of the stationary storage battery, and an increased discharge of the traction storage battery.

4. The power management apparatus according to claim 1,
further comprising a small-scale vehicle group classifier that classifies the vehicle into a plurality of small-scale vehicle groups.

5. The power management apparatus according to claim 1, further comprising:
a standby reward manager that manages a reward to a user who has accepted the demand response request and has been on standby; and
a record-based reward manager that manages a reward to a user who has accepted the demand response request and has executed the demand response.

6. The power management apparatus according to claim 5, wherein
in a case where the demand response request is a request for increasing power demand, the standby reward manager does not give a reward to the user.

7. The power management apparatus according to claim 5, wherein
in a case where the demand response request is a request for reducing power demand, the standby reward manager gives a reward to the user.

8. A power management method, wherein
a computer of a power management apparatus
accepts a demand response request for maintaining a supply and demand balance of electric power,
causes a power regulation resource including a traction storage battery of a vehicle and a stationary storage battery of a battery energy storage system to execute the demand response request, and
determines priority order of the traction storage battery and the stationary storage battery, based on a type of the demand response request.
